(19) United States
(12) Patent Application Publication
(10) Pub. No.: US 2023/0146763 A1
(43) Pub. Date: May 11, 2023

(54) Non-destructive Evaluation System for Detecting Delamination in Concrete Structures

(71) Applicants: Ebi Maher, Priceton Junction, NJ (US); Xiao Meng, Ewing, NJ (US); Syed Zain, East Windsor, NJ (US)

(72) Inventors: Ebi Maher, Priceton Junction, NJ (US); Xiao Meng, Ewing, NJ (US); Syed Zain, East Windsor, NJ (US)

(21) Appl. No.: 17/749,042

(22) Filed: May 19, 2022

Related U.S. Application Data
(60) Provisional application No. 63/192,045, filed on May 23, 2021.

(51) Int. Cl. G01N 29/04; G01N 29/46; G01N 29/44

(52) U.S. Cl. CPC G01N 29/045; G01N 29/041; G01N 29/46; G01N 29/4463; G01N 2291/014; G01N 2291/0232

(57) ABSTRACT

Disclosed are non-destructive evaluation systems and method thereof for detecting delamination, overlay debonding, spalling and detecting and differentiating between sound and delaminated patches in concrete structures. The non-destructive evaluation method for detecting delamination in concrete structures includes obtaining a plurality of acoustic waves, storing the plurality of acoustic waves, calculating a short-term Fourier transform (STFT) spectrum for each of the plurality of acoustic waves, wherein each STFT spectrum comprises a plurality of window discrete Fourier transforms, and detecting the delamination based on the STFT spectrum.

### RELATED APPLICATION

This application claims priority under 35 USC 119 to U.S. Provisional Pat. application no. , filed May 23, 2021, which the disclosure of such is incorporated herein by reference in its entirety.

### TECHNICAL FIELD

This application relates to a system for non-destructive evaluation. More particularly, this application relates to a system for non-destructive evaluation of concrete structures.

### BACKGROUND

Bridges, buildings, tunnels, runways, dams, cooling towers, parking garages, and other concrete structures require constant maintenance. They should be inspected regularly for possible defects to detect deterioration, delamination or corrosion. Delamination and reinforcement corrosion are two common defects with concrete structures. Various non-destructive testing or non-destructive evaluation methods are utilized to detect defects for concrete structures. Traditional non-destructive evaluation methods mainly rely on visual inspection, which are prone to human error, and require site closure, and are thus, unreliable, and slow. Accordingly, there is a need for a non-destructive evaluation method which is economically affordable, simple to use, safe and reliable, without a need to disrupt the public, and automated without being subject to human error.

### SUMMARY

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

According to an aspect of the present disclosure, a method for detecting delamination in structures is disclosed. The method for detecting delamination in structures may include obtaining a plurality of acoustic waves, storing the plurality of acoustic waves, calculating a short-term Fourier transform (STFT) spectrum for each of the plurality of acoustic waves, wherein each STFT spectrum comprises a plurality of window discrete Fourier transforms, and detecting the delamination based on the STFT spectrum.

The method for detecting delamination in structures may further include storing synchronous geotag data associated with each of plurality of acoustic waves. The synchronous geotag data may be determined by utilizing at least one of: an encoder, a Global Positioning System (GPS) data, an Inertial Measurement Unit (IMU) data, and a Light Detection and Raging (LiDAR) data. Prior to the detecting the delamination, the method for detecting delamination in structures may include isolating an inspection area for detecting the delamination, and band passing-filter the plurality of acoustic waves. The isolating an inspection area may be performed by using at least one of: a 360° video of the inspection area, a profiler position, the GPS data, the IMU data, the LiDAR data, and a Line Scan Camera (LSC) data.

In some embodiments, the method for detecting delamination in structures may include calculating an average absolute amplitude for each acoustic wave of the plurality of acoustic waves, and normalizing each average absolute amplitude. The detecting the delamination based on the STFT spectrum may include identifying each acoustic wave of the plurality of acoustic waves having a resonance frequency between 0.5 kHz to 5 kHz, calculating a total number of points based on a sampling rate for each STFT, calculating a number of overlap points for each STFT, calculating a signal energy curve over a first frequency range for each STFT and normalizing the signal energy curve for each STFT. The normalizing the signal energy curve may be performed based at least in part on utilizing an asphalt energy. The first frequency range may be between 1 kHz and 4 kHz. The method for detecting delamination in structures may further include cross-checking the plurality of acoustic waves to identify outlier acoustic waves and removing the outlier acoustic waves. The obtaining the plurality of acoustic waves may include dragging a set of chains along a surface of the structure, removing a first set of sounds created by the set of chains contacting the surface, and removing a second set of sounds created by the set of chains contacting each other.

In some embodiments, the obtaining the plurality of acoustic waves may include transmitting one or more acoustic waves towards the surface, collecting reflected acoustic waves from the surface in response to transmitting the one or more acoustic waves, and storing the collected acoustic waves.

According to some embodiments, the detecting the delamination based on the STFT spectrum may include calculating a signal energy for each STFT window by integrating the STFT spectrum over a second frequency range. An upper bound and a lower bound of the second frequency range may be adjustable.

According to some embodiments of the present disclosure, a system for detecting delamination in a structure is disclosed. The system for detecting delamination in a structure may include a data acquisition unit, which may be configured to obtain a plurality of acoustic waves, and store the plurality of acoustic waves. The system for detecting delamination in a structure may further include a data processing unit, which may be configured to calculate a short-term Fourier transform (STFT) spectrum for each of the plurality of acoustic waves. Each STFT spectrum may include a plurality of window discrete Furrier transforms. The data processing unit may further be configured to detect the delamination based on the STFT spectrum.

The data acquisition unit may include one or more chambers, one or more microphones configured to collect the acoustic waves, and an apparatus coupled to the one or more microphones. The apparatus may be configured to receive and store voltage signals, corresponding to the acoustic waves, from the one or more microphones. The data processing unit may be further configured to calculate a mean energy of each of the one or more microphones for an entire scan to normalize an individual microphone’s STFT spectrum.

In some embodiments, the system for detecting delamination in in a structure may include one or more chains, each chain being mounted inside each of the one or more chambers, wherein the one or more chains are configured to drag along a surface of the structure, and a chain positioning unit configured to control movement of each chain. The acoustic waves may be created by each chains dragging along a surface of the structure. At least one of the one or more chains may be in contact with the surface at each time to ensure inspecting an entire surface of the structure, and the chain positioning unit may include a set of inverse T-shaped bars.

The data acquisition unit may further include a reconfigurable I/O module, and at least one of the one or more microphones may be a Micro-Electro-Mechanical-System (MEMS) microphone. A linear response of the MEMS microphone may be about 124 dB sound pressure level, with a sensitivity tolerance of about 1 dB and an enhanced immunity to at least one of: a radiated Radio Frequency (RF) interference, and a conducted RF interference.

### BRIEF DESCRIPTION OF THE DRAWINGS

Various embodiments will be described herein with reference to the drawings wherein:

FIG. 1 illustrates a schematic non-destructive evaluation system for detecting delamination in a structure, in accordance with some embodiments.

FIGS. 2A-2E illustrate a sound collecting chamber, in accordance with some embodiments.

FIGS. 3A-3D illustrate sound collecting chamber and T-shaped chain positioner, in accordance with some embodiments.

### DETAILED DESCRIPTION

The following disclosure provides several different embodiments, or examples, for implementing different features of the provided subject matter. Specific examples of components and features are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation illustrated in the figures. The apparatus may be otherwise oriented (rotated 90 degrees or at other orientations) and the spatially relative descriptors used herein may likewise be interpreted accordingly.

Herein, a non-destructive evaluation system for detecting deterioration in concrete structures is described. The non-destructive evaluation system for detecting delamination in concrete structures is configured to locate all shallow delamination with high accuracy. The non-destructive evaluation system for detecting delamination in concrete structures is further configured to accurately determine the size of each shallow delamination area. Furthermore, the non-destructive evaluation system for detecting delamination in concrete structures is configured to detect debonding, spalling as well as detecting and differentiating between sound and delaminated (unsound) patches and patched areas. In the case of bridge deck inspection, unlike manual hammer or chain drag methods, the data acquisition unit and data processing unit of the disclosed non-destructive evaluation system for detecting delamination in concrete structures does not need lane closure (e.g., a roadway traffic lane an airport runway), or site closure (e.g., entire bridge deck or a parking garage). Furthermore, since the vehicle speed is high enough to not create trouble for the public, the non-destructive evaluation system for detecting delamination in concrete structures is safe and does not cause any damage to the roads or public.

In some embodiments, the non-destructive evaluation system for detecting delamination in concrete structures is coupled with a data acquisition unit which may collect data from microphones and a data processing unit to process the data and produce results in the form of contour maps. The non-destructive evaluation system for detecting delamination in concrete structures may be located inside a vehicle. Alternatively, the non-destructive evaluation system for detecting delamination in concrete structures may be mounted on a vehicle. In some embodiments, one or more parts of the non-destructive evaluation system for detecting delamination in concrete structures may be located inside the vehicle, and one or more parts of the non-destructive evaluation system for detecting delamination in concrete structures may be mounted on the vehicle. A sound record is the final output of the hardware compartment. In some embodiments, there may be 6 sound records every time the vehicle drives across an inspection area, one from each microphone which is installed on each sound collecting chamber. Each drive-across-inspection-area (i.e., pass) can cover parts of an inspection area. Depending on the total width of an inspection area, there may be multiple passes.

Once the sound is recorded, a data processing unit processes the sound based on the sound’s frequency, amplitude and relative energy distribution within a specified frequency band to identify possible shallow delamination, debonding, spalling and detecting and differentiating between sound and delaminated patches. The non-destructive evaluation system for detecting delamination in concrete structures prepares a contour map of the inspection area. The contour map can be analyzed, and a conclusion and recommendation of the inspection area condition can be created.

Nondestructive evaluation (NDE) includes analysis techniques used to evaluate properties of a material, structure, or system without causing damage. During a typical NDE, the inspected structure is not permanently altered, making the NDE a valuable technique that is cost effective and time saving.

Disclosed is an NDE method which relies upon use of acoustic waves (i.e., sound waves) to examine concrete structures including bridge decks. Typically, a mechanical signal (i.e., sound) created by dragging a chain on the concrete structure is collected from the microphones and evaluated by a computer software to detect possible defects (i.e., failures) on the concrete structure. In case of detecting a failure, the sound changes from a first state (e.g., usually a clear ringing sound) to a second state (e.g., a hollow sound). The NDE method can be used to evaluate integrity, composition, or condition of the concrete structure with no alteration of the concrete structure.

A material fracturing into layers is called delamination. Delamination is one of the most common defects in concrete structures, which can occur over time and as a result of traffic on a concrete structure, e.g., a bridge deck. This defect can seriously affect life span and safety of the concrete structure. Commercial methods to detect delamination use human perception. That is, an operator is trained to detect defects by hearing or observing the defect. Needless to say, this process is prone to human error and is not suitable, even feasible, for numerous concrete structures across the country. The speed of chain drag can vary with the level of deterioration of the concrete structure and the experience of the inspector. Present disclosure uses drag chains which, on a high level, includes using acoustic sensors (i.e., microphones) to collect mechanical signals (i.e., sound) resulting from a chain dragging on the concrete structure. The collected sounds are analyzed by special-designed software programs dedicated to detecting delamination in the concrete structure. The chain drag method is a fast method for determining the location of moderate to severe delaminated area on a concrete structure.

Herein, a non-destructive evaluation system for detecting delamination in concrete structures is described. The non-destructive evaluation system for detecting delamination in concrete structures is configured to locate all shallow delamination on the concrete structure with high accuracy. The non-destructive evaluation system for detecting delamination in concrete structures is further configured to accurately determine the size of each shallow delamination area. In the case of bridge deck inspection, unlike manual chain drag methods, the data acquisition unit of the disclosed non-destructive evaluation system for detecting delamination in concrete structures does not need traffic control. Furthermore, since the vehicle speed is high enough to not create trouble for the public, the non-destructive evaluation system for detecting delamination in concrete structures is safe and does not cause any damage to the roads or public.

In some embodiments, the non-destructive evaluation system for detecting delamination in concrete structures is coupled with a data acquisition unit which may collect data from microphones and a data processing unit to process the data and produce results in the form of contour maps. The non-destructive evaluation system for detecting delamination in concrete structures may be located inside a vehicle. Alternatively, the non-destructive evaluation system for detecting delamination in concrete structures may be mounted on a vehicle. In some embodiments, one or more parts of the non-destructive evaluation system for detecting delamination in concrete structures may be located inside the vehicle, and one or more parts of the non-destructive evaluation system for detecting delamination in concrete structures may be mounted on the vehicle. A sound record is the final output of the hardware compartment. In some embodiments, there may be 6 sound records every time the vehicle drives across an inspection area, one from each microphone which is installed on each sound collecting chamber. Each drive-across-inspection-area (i.e., pass) can cover parts of an inspection area. Depending on the total width of an inspection area, there may be multiple passes.

Once the sound is recorded, a data processing unit processes the sound based on the sound’s frequency, amplitude, and relative energy distribution within a specified frequency band to identify possible shallow delamination, debonding, spalling and detecting and differentiating between sound and delaminated patches. The non-destructive evaluation system for detecting delamination in concrete structures prepares a contour map of the inspection area. The contour map can be analyzed, and a conclusion and recommendation of the inspection area condition can be created.

The non-destructive evaluation system for detecting delamination in concrete structures is used for concrete structure inspection, and in particular to detect shallow delamination. An objective of the present disclosure is to accurately detect shallow delamination, overlay debonding, spalling and detecting and differentiating between sound and delaminated patches by utilizing an automated chain drag microphone data processing unit, and to generate a deterioration/delamination contour map of the concrete structure. An algorithm is developed which is independent of testing speed and can dynamically account for the testing speed to meet or exceed manual chain drag performance, accuracy, and reliability.

In some embodiments, the non-destructive evaluation system for detecting delamination in concrete structures is located on a back of a vehicle (e.g., a van), underneath the chassis. The non-destructive evaluation system for detecting delamination in concrete structures is mounted rigidly on the vehicle using a vehicle hitch. It should be noted that, in some embodiments, the non-destructive evaluation system for detecting delamination in concrete structures is used as an individual module on its own without the vehicle.

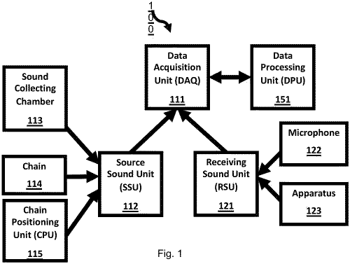

FIG. 1 illustrates a schematic non-destructive evaluation system for detecting delamination in concrete structures 100. The non-destructive evaluation system for detecting delamination in concrete structures 100 may include a data acquisition unit (DAQ) 101 and a Data Processing Unit (DPU) 151. In some embodiments, the DAQ 101 may collect data (i.e., sound signals). In some embodiments, the output of the DAQ may be sound records, which may be transmitted to the DPU 151. The DPU 151 may receive the sound records from the DAQ 101, may process the sound records, and may further generate contour maps based on the sound records.

In some embodiments, the DAQ 101 may include a source sound unit (SSU) 112 and a receiving sound unit (RSU) 121. The SSU 112 may include a sound collecting chamber 111, a chain 114 in each sound collecting chamber 111, and a chain positioning unit (CPU) 115. The RSU 121 may include one or more microphones 122 and an apparatus 123 configured to read and acquire microphone voltage signals.

The DAQ 101 may be in communication with the DPU 151. In some embodiments, the non-destructive evaluation system for detecting delamination in concrete structures 100 may include more than one sound collecting chamber 111. As a non-limiting example, the non-destructive evaluation system for detecting delamination in concrete structures 100 can include 2, 3, 4, 5, 6, or any number of sound collecting chambers. In some embodiments, the SSU 112 and the RSU 121 may be collectively called the DAQ 101. The sound collecting chamber 111 may collect sound created by contacting the chain 114 with the concrete structure surface and transmit the resulting sound to the DPU 151 for processing.

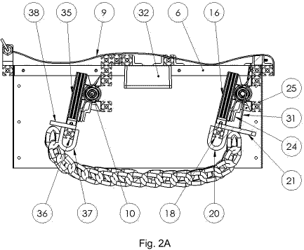

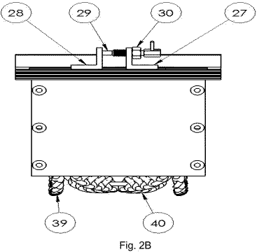

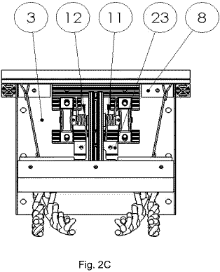

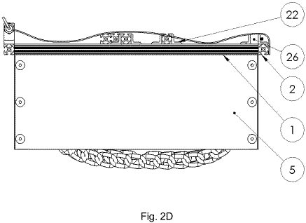

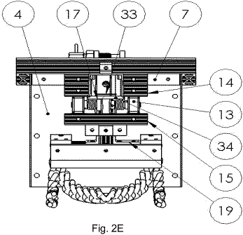

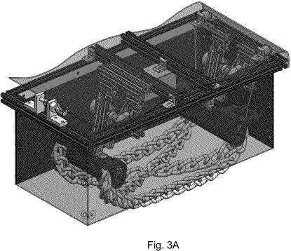

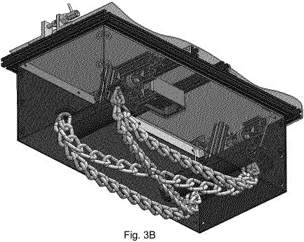

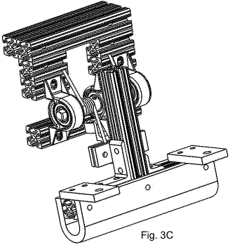

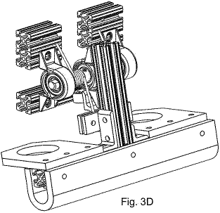

FIGS. 2A-2E illustrate a sound collecting chamber from different views. T-shaped chain positioner can be seen in FIGS. 3A-3D. The sound collecting chamber 111 may include a plurality of frames that are connected to each other through commercially available components. In some embodiments, the sound collecting chamber 111 may be configured to isolate a microphone from ambient noise. In some embodiments, the sound collecting chamber 111 of the DAQ 101 may be configured to utilize vibration isolation components to minimize and/or eliminate vibration transferred from the system into microphone which may cause noise. In some embodiments, the sound collecting chamber 111 may include 2, 3 or any number of T-shaped chain positioner 115.

Referring now to FIGS. 2A-2E, in some embodiments, the sound collecting chamber 111 may include a plurality of chamber frames 1 and 2, a plunger 29, plunger mounts 27 and 28 and plunger locking nut 30, a plurality of rubber walls 3, 4, 5, 9, and rubber wall clamp plates 6, 7, and 8, a shaft 10; a plurality of springs 11 and 12 and spring clamp plates 23, a plurality of bearings 13 and bearing mounting bars 14 and 15, a spacer 17, a plurality of brackets 19 and 22, a plurality of rubber cushions 20 and 37 and a rubber ring 21, a damper 25 and a damper mount 24, a plurality of mechanical fuses 26, a plurality of wire ropes 31, a microphone enclosure 32 and a microphone board 33 and a microphone foam 34, a plurality of T-shaped bars 16, 18, 35 and 36, a rubber mount 38, a chain straight 39, and a chain cross 40. In some embodiments, the sound collecting chamber 111 may include additional components such as, but not limited to, cables, cable management components, sound-absorbing foam, microphone mounting adapter, grommet, mechanical fasteners, etc. Furthermore, in some embodiments, not all of the above-mentioned components are present.

In some embodiments, the plurality of chamber frames 1 and 2 may include two long frame chambers 1, and four short chamber frames 2. As a non-limiting example, the plurality of chamber frames may include black 80-20 frames which are located on top of the sound collecting chamber 111. As another non-limiting example, the plurality of chamber frames 1 and 2 may include rails having continuous T-slots which can be used for attaching fittings. In some. embodiments, the rails may be made of aluminum or any other suitable material.

In some embodiments, the plurality of rubber walls 3, 4, 5, and 9 may include black abrasion-resistant styrene butadiene rubber sheets as surrounding walls. The rubber wall clamp plates 6, 7, and 8 may include any suitable clamp plates known in the art. A bottom of the sound collecting chamber 111 may be open. The chain 39 and 40 may be in contact with the ground via the open bottom of the sound collecting chamber 111. Contacting the ground and the chain 39 and 40 may create a sound which is collected and stored.

In some embodiments, the chain may be configured to be a sound source. Each sound collecting chamber 111 may have a chain cross 40 mounted in the middle in a letter X shape, and 2 of chain straight 39 mounted parallel on the sides. In some embodiments, such a chain configuration may maximize contact area between chain 39, 40 and ground which increase S/N ratio and decrease chance of missing data. As a non-limiting example, the chain 39 and 40 may include a 3/8″ grade 30 galvanized steel chain. In some embodiments, the non-destructive evaluation system for detecting delamination in concrete structures may be installed on a vehicle. In such embodiments, while the vehicle is moving, e.g., across a bridge, with the chains 39 and 40 deployed, the chain 39 and 40 may contact with the ground and bounce up and down. In some embodiments, sound created from dragging the chain 39 and 40 along the ground may be further removed from the sound created from chain’s impact with the ground. In some embodiments, the DPU 151 may filter out sound created by chain links contacting each other. The resulting interactions between the chain 39, 40 and the ground may create vibration, e.g., in the concrete deck, which can be sensed and recorded by the microphone on the microphone board 33. Thus, the chain 39 and 40 may act as the sound source, and the microphone is the sound receiver, i.e., sensor. In some embodiments, the chain 39 and 40 may be replaced by another sound source which works without contacting the grounds. As a non-limiting example, one or more speakers may replace the chain 39 and 40 to collect sound signals resulted from exciting the shallow delaminations. To that end, the one or more speakers may impart energy into the ground, i.e., the bridge deck, to excite flexural resonance mode of shallow delamination. The DPU 151 may analyze the reflected sound signals from the ground by comparing and contrasting the reflected sound waves with the sound signals emitted from the one or more speakers.

In some embodiments, the sound collecting chamber 111 may include 2 chain positioners, as shown in FIGS. 3A-3B. The chain positioners, i.e., the CPU 115 as shown in FIG. 1, may include the plurality of T-shaped bars 16, 18, 35 and 36, the rubber cushion 20 and 37, and a rubber ring 21 the damper 25 and the damper mount 24. The chain positioners may have an inverse T-shape (upside-down letter T) and may be configured to position the chain 39 and 40. The T-shaped chain positioners may keep the chain 39 and 40 down and close to the ground, and decrease up and down movement (e.g., jumping) of the chain 39 and 40 when the vehicle, or the non-destructive evaluation system for detecting delamination in concrete structures, is moving. In some embodiments, at each time, at least one chain 39 and 40 of one the sound collecting chambers 111 may be in contact with the ground. Thus, in some embodiments, the non-destructive evaluation system for detecting delamination in concrete structures may constantly collect data signals from contacting the chain 39 and 40 with the concrete structure surface, ensuring the entire inspection area is swept to detect delamination with no missing points.

In some embodiments, the plurality of springs 11 and 12 may include torsion springs. A torsion spring may work by twisting an end along an axis. In other words, the torsion spring may be a flexible elastic object that stores mechanical energy when the spring is twisted. When each of the plurality of spring 11 and 12 is twisted, it may exert a torque in an opposite direction, proportional to the amount (i.e., angle) the spring is twisted. The torsion springs may be used to passively keep the chain 39 and 40 down. In some embodiments, the plurality of springs 11 and 12 may also swivel around an axis that is perpendicular to the chain 39 and 40, thus, if the T-shaped chain positioner hits something on the inspection area surface, it may swing up towards the back with the chain 39 and 40, instead of breaking.

Referring to FIGS. 2A-2E again, in some embodiments, the microphone board 30 may be located inside the microphone enclosure 32 and be protected by the microphone foam 34. In some embodiments, the microphone foam 34 may be further configured to dampen the sound collected by the microphone and absorb noise to increase data signal-to-noise ratio. A microphone may be installed on the microhome board 33 and acts as a ‘receiver’ or ‘sensor’ of the non-destructive evaluation system for detecting delamination in concrete structures. Each sound collecting chamber 111 may have one microphone mounted in a center towards a top of the sound collecting chamber 111. In some embodiments, the microphone board 33 may include a Printed Board Circuit (PCB). Typically, a PCB mechanically may support and electrically connect electrical or electronic components using conductive tracks, pads and other features etched from one or more sheet layers of copper laminated onto and/or between sheet layers of a non-conductive substrate.

In some embodiments, the PCB(s) and the microphone(s) may form the data acquisition (DAQ) unit. In some embodiments, the DAQ unit may be same as the data processing unit. In some embodiments, the DAQ unit may be separate from and in communication with the data processing unit. In some embodiments, the DAQ unit may be part of the data processing unit. The DAQ unit may be configured to read and acquire (i.e., log) microphone voltage signals. As a non-limiting example, the DAQ unit may include a compact reconfigurable I/O module, such as a cRIO manufactured by National Instrument Corporation (NI). In some embodiments, there may be one or more Micro-Electro-Mechanical-Systems (MEMS) microphones (e.g., 4 MEMS) on each PCB. As a non-limiting example, an analog MEMS microphone with high signal-to-noise (SNR) and enhanced radio frequency (RF) immunity may be used. The MEMS microphone may be coupled with an impedance converter, and an output amplifier. The MEMS microphone’s linear response may be around 124 dB sound pressure level (SPL), with a tight ±1 dB sensitivity tolerance and an enhanced immunity to both radiated and conducted RF interference. The MEMS and/or microphones may be mounted on either a rigid or flexible PCB. In some embodiments, the PCB may include low pass filters, high pass filters, bandpass filters and/or notch filters to filter the signal as required by the application. In some embodiments, the MEMS microphone’s linear response may be higher than 124 dB, e.g., 150 dB, 200 dB, etc. In some embodiments, microphone’s lid may be attached directly to the rubber walls of the sound collecting chamber 111. Alternatively, in some embodiments, the microphone’s lid may be attached to the microphone board 33 inside the microphone enclosure 32 using an adhesive layer.

In some embodiments, the microphone’s flat frequency response may be between 1 kHz to 10 kHz. In some embodiments, the microphone’s flat frequency response may be between 0 kHz to 20 kHz. In some embodiments, the microphone may have high SNR and acoustic overload point (to prevent clipping). The PCB may be housed within a protective enclosure (e.g., the microphone enclosure 32), and the PCB and the microphones may be covered with microphone foam 34 (e.g., foam padding) to prevent microphone clipping at higher speeds. In various embodiments, type, amount and structure of the foam padding may be so selected that the foam padding does not absorb/attenuate frequencies within 500 Hz to 5 kHz. In some embodiments, type, amount and structure of the foam padding may be so selected that the foam padding does not absorb/attenuate frequencies between 0 Hz to 10 kHz. In some embodiments, the PCB may be powered using direct current. As an example, the PCB may be powered using 3.3 V.

In some embodiments, the DAQ unit may include a controller. As a non-limiting example, the controller may be a 1.3 GHz Dual-Core controller, with 70T FPGA, 8-Slot, RT, and non-XT. A module may be used for acquiring AC microphone data. As a non-limiting example, the module may be a 4-Ch, 51.2 kS/s, IEPE and AC/DC. In some embodiments, sampling may be performed at 51.2 kHz rate. It should be noted that, the sampling rate can be changed depending on the application and its requirements.

Data collected by and received from the microphone may be saved with synchronous geotag information. In some embodiments, the geotag information may be determined by utilizing an encoder. In some embodiments, the geotag information may be determined by utilizing Global Positioning System (GPS) data. In some embodiments, the geotag information may be determined by utilizing Inertial Measurement Unit (IMU). In some embodiments, the geotag information may be determined by utilizing Light Detection and Ranging (LiDAR). In some embodiments, the geotag information may be determined by utilizing a combination of the above (encoder, GPS, IMU, LiDAR).

Upon receiving the data from the microphone, real-time and post-data-collection algorithm may check whether the microphones are functioning correctly, that no clipping is occurring, and that the chains 39 and 40 are effectively deployed. In some embodiments, all incoming data from the microphone may be cross-checked and compared to identify outliers. In such embodiments, the outliers may be removed from further processing.

When the non-destructive evaluation system for detecting delamination in concrete structures may collect data from an inspection area, a “pass” or “scan” for data collection is performed for the inspection area. However, depending on a width of the inspection area, in some embodiments, the area may require more than one pass. In some embodiments, a pass may include some area before and after the inspection area as well. As a non-limiting example, at least 300 ft before and after a bridge lane may be swept by the non-destructive evaluation system for detecting delamination in concrete structures. For each pass, the collected data may be saved. As a non-limiting example, the data may be saved in an hdf5 file. The saved data (e.g., the hdf5 file) may contain the data of each microphone (i.e., in case of multiple sound collecting chambers), for the entire pass (i.e., before the inspection area, on the inspection area, and after the inspection area).

In some embodiments, each microphone may be sampled at 51.2 kHz. That is, 51200 voltage readings may be acquired every second from each microphone. On the saved file (i.e., the hdf5 file), each microphone may have a corresponding row which may include data gathered by that microphone. Consecutive voltage readings (i.e., samples) may be saved in consecutive column within the row assigned to that microphone. In some embodiments, the voltage readings may fluctuate between 0 VDC and 3.3 VDC, and the bias voltage may be 1.65 VDC. In some embodiments, each voltage reading may also be associated and tagged with the current encoder count (i.e., position), profiler count (i.e., position), GPS coordinates (i.e., GPS PPS), IMU (i.e., pitch, roll, yaw, etc.) information. Additionally, in some embodiments, the voltage reading may be associated and tagged with Light Detection and Ranging (LiDAR) information (i.e., transverse distance from barrier, etc.). In some embodiments, each microphone time domain signal may represent a 1-D linear scan.

In some embodiments, prior to processing the data collected by the microphones, the processing unit may use one or more or a combination of a 360 video, the profiler position, the GPS coordinates, the IMU information, the LiDAR data, the GPR (Ground Penetrating Radar) data and the LSC (Line Scan Camera) data to isolate the inspection area in the pass, including inspection area start and end skews if present, for further processing. In some embodiments, pre-processing can be performed manually. Alternatively, in some embodiments, the data processing unit may perform the pre-processing automatically. The data processing unit may bandpass-filter the data collected by and received from the microphone. The bandpass filtering may remove data/frequencies outside a bandwidth of interest. For example, in some embodiments, by utilizing the bandpass-filtering, the data processing unit may remove frequencies above 10 kHz and below 500 Hz. In some embodiments, the data processing unit may normalize the average absolute amplitude of each microphones recorded data signal before further processing.

In some embodiments, shallow delaminations primarily may have a resonance frequency between 500 Hz to 5000 Hz. Typically, the resonance frequency may range from 0.5 to 5 kHz for delaminations with a depth of 2.5-7.5 cm and width of 0.2-1 m. Accordingly, in some embodiments, the data processing unit may use the resonance responses in 0.5-5 kHz frequency range to identify the potential existence of delaminations.

In some embodiments, the data processing unit may compute a short-term Fourier transform (STFT) spectrogram for each microphone time domain signal (1-D linear scan). Typically, STFT may be used to determine sinusoidal frequency and phase content of local sections of a signal as it changes over time. The procedure for computing STFT may include dividing a longer time signal into shorter segments of equal length and then compute the Fourier transform separately on each shorter segment to reveal the Fourier spectrum on each shorter segment. A spectrogram may be a plot of the changing spectra as a function of time. The STFT may be composed of rectangular-window discrete Fourier transforms and be computed with an overlap window. In some embodiments, the number of points utilized for each STFT window may be variable. Similarly, in some embodiments, the number of overlap points between consecutive STFT windows may be variable.

In some embodiments, based on the longitudinal distance that each STFT window should represent (e.g., 3 inches), the data processing unit may calculate the number of points in each STFT window by utilizing the speed of the non-destructive evaluation system for detecting delamination in concrete structures and the sampling rate. The data processing unit may calculate the number of overlap points, similarly. Alternatively, in some embodiments, the data processing unit may utilize a fixed number of points for the STFT window and the overlap.

In some embodiments, the number of overlap points may vary by assigning a desired percentage overlap between consecutive windows. In such embodiments, for example, 0% may indicate no overlap points, while 100% may indicate a complete overlap between consecutive STFT windows.

In some embodiments, the number of points in each STFT window may be dependent on the testing speed. That is, number of points in STFT window and testing speed may be inversely proportional. In some embodiments, the data processing unit may use fixed window size at a certain number of points for STFT calculations. This may ensure energy levels consistency. In some embodiments, the data processing unit may use a smaller window for faster testing speeds. On the other hand, in some embodiments, the data processing unit may use a larger window for slower testing speeds.

The data processing unit may calculate signal energy (SE) for each STFT window. To that end, the data processing unit may integrate the STFT power spectrum over the frequency range [f₁, f₂], where [f₁, f₂] may be adjustable frequencies. In some embodiments, the data processing unit may use [500, 5000] as the frequency range. Alternatively, in some embodiments, the data processing unit may use [1000, 4000] as the frequency range. In some embodiments, the data processing unit may use [1500, 3000] as the frequency range. Alternatively, in some embodiments, the data processing unit may use [1500, 9000] as the frequency range.

Since the shallow delaminations primarily may have a resonance frequency between 500 Hz to 5000 Hz, the signal energy SE may increase over a shallow delamination. This signal energy calculation process may be repeated for each microphone channel and a signal energy curve SE(t) may be obtained for each microphone channel. Subsequently, the data processing unit may normalize the signal energy curves from all microphone channels. The data processing may normalize the signal energy curves through various methods.

In some embodiments, the data processing unit first may sort an individual microphone’s STFT energies in an ascending order. Once the microphone’s STFT energies are sorted in ascending order, the data processing unit then may calculate an average of the lowest mean energy percent threshold (i.e., x %) of total values and use this number to normalize all STFT energies for the specific microphone.

Alternatively, in some embodiments, the data processing unit first may sort an individual microphone’s STFT energies in a descending order. Once the individual microphone’s STFT energies are sorted in a descending order, the data processing unit then may calculate an average of the highest x % of total values and use this number to normalize all STFT energies for that specific microphone. As a non-limiting example, once each microphone encounters a shallow delamination that produces a hollow sound (i.e., highest band energy), the data processing unit may normalize the maximum delamination energy produced to 1 for all microphones. In such a case, all other energies may be relative to the maximum delamination energy utilized for normalization.

Alternatively, in some embodiments, the data processing unit may use asphalt energy prior to the inspection area to normalize all STFT energies for an individual microphone.

Alternatively, in some embodiments, the data processing unit may use mean (i.e., average) energy of microphone for the entire scan to normalize an individual microphone’s STFT energies. The scan may include over inspection area only, or before- and after-inspection area as well.

Alternatively, in some embodiments, the data processing unit may normalize each individual microphones STFT energies in the frequency band [ƒ1,ƒ2] by utilizing that specific microphones STFT energies in a separate frequency band [ƒ3,ƒ4]. In some embodiments, the separate frequency band [ƒ3, ƒ4] may overlap with the frequency band [ƒ1, ƒ2]. In some embodiments, the separate frequency band [ƒ3, ƒ4] may not overlap with the frequency band [ƒ1, ƒ2]. The data processing unit may perform the above-mentioned process for each STFT window separately. For example, if [ƒ1, ƒ2] are [500, 5000] and [ƒ3, ƒ4] are [10000, 15000], and the STFT window energy for a microphone is SE [500,5000] over the bandwidth [ƒ1, ƒ2] and the STFT window energy for a microphone is SE [10000,15000] over the bandwidth [ƒ3,ƒ4], the normalized energy for that microphone STFT window may be the ratio SE [500,5000] / SE [10000,15000]. In some embodiments, the data processing unit may use two or more of the above-mentioned methods to normalize the signal energy curves from all microphone channels.

Once the data processing unit normalizes the signal energy curves from all microphone channels, the data processing unit may optionally convert the normalized signal energy curves from all the microphone channels to dB. In some embodiments, the data processing unit may apply a spatially low-pass filter to the normalized signal energy curves. That is, after using any of the above-mentioned normalization methods or a combination thereof, the data processing unit may convert the normalized signal energy curves to dB and/or applies a low-pass filter or moving average filter. Subsequently, the data processing unit may combine the result to form a 2-D matrix SE (t, n), where n may be the total number of microphone channel, and t is time.

The data processing unit then may replace the time axis and the channel number axis by the longitudinal and transverse position coordinates, respectively, to form a 2-D matrix SE (1, t) where 1 is the longitudinal distance (in ft) and t is the transverse distance (in ft). To that end, the data processing unit may utilize at least one of an associated encoder counts, a profiler position counts, and known transverse distance between microphones, to generate a 2-D delamination contour map of the pass. In some embodiments, known transverse distance between microphones may be constant. In such instances, the data processing unit may use an interpolation method between data points for generating the contour map.

In some embodiments, the data processing unit may apply a spatial moving average filter to the 2-D matrix SE (1, t). Each cell (element) in the 2-D matrix SE (1, t) may be replaced by the average of all cells contained within a rectangle of odd length and width that is centered on the cell (element) in consideration, where the length and width can be any odd integer. This process may be repeated for each cell (element) in the 2-D matrix SE (1, t). The result of this procedure may be to cluster multiple small delaminations that are spatially located near one another into one larger delamination to more accurately identify the delaminated area that will have to be repaired.

In some embodiments, the data processing unit may use a minimum normalized energy threshold for delamination to isolate and extract only areas that exhibit a high likelihood of containing a shallow delamination for displaying on the generated 2-D delamination contour map. The minimum normalized energy threshold may be defined as x% of the maximum normalized energy value for each microphone in a pass, where x is variable between 0 and 100. Furthermore, the minimum normalized energy threshold may be defined such that x% of normalized energy values for each microphone are above or below the minimum normalized energy threshold, where x is variable between 0 and 100. Furthermore, the minimum normalized energy threshold may be defined as a hard coded number, which will differ from bridge to bridge, but will typically be in the range of 1 to 25. The minimum normalized energy threshold may depend on testing speed and surface type and may differ between passes and/or bridges and/or other concrete structures. In such instances, the data processing unit may use interpolation between data points for generating the contour map. In some embodiments, such a process may be repeated for each pass.

In some embodiments, the produced 2-D delamination contour map may be converted to a binary image, depicting only delaminated areas and sound (non-delaminated) areas. In some embodiments, the 2-D contour map and binary image may be resized to make the real-world length and width represented by a single pixel equivalent. In some embodiments, the produced 2-D contour map and/or the binary image may utilize bounding boxes around delaminations to automatically identify their size (length, width), area and location. In some embodiments, the delaminated area may be calculated and is further used to calculate/determine the percentage of the inspection area that is delaminated.

In some embodiments, the data processing unit may utilize multiple normalized energy thresholds to isolate and extract areas that exhibit a low, medium, and high likelihood of containing a shallow delamination for displaying on the generated 2-D delamination contour map. The produced contour map may utilize different colors to represent and differentiate between areas with low, medium and high probability of shallow delamination. The multiple normalized energy thresholds may be the same for all microphones in a pass, different for all microphones in a pass and may be dependent on an individual microphones normalized energy median, mean or mode. In some embodiments, for each normalized threshold, the delaminated area may be calculated and is further used to calculate/determine the percentage of the inspection area that is delaminated.

In some embodiments, the data processing unit may use at least one of the GPS information associated with each pass, the IMU information associated with each pass, the encoder and profiler position information associated with each pass, the GPR and LSC data associated with each pass, or the LiDAR information associated with each pass. The data processing unit may combine 2-D delamination contour maps of individual passes to generate an overview 2-D delamination contour map of the entire inspection area. In such instances, the data processing unit may use interpolation between data points for generating the contour map. The above techniques regarding isolating and extracting only areas that exhibit a high likelihood of containing a shallow delamination may also be utilized for the overview 2-D delamination contour map. In some embodiments, the delaminated area in the overview 2-D delamination map of the entire inspection area may be calculated and may be further used to calculate/determine the percentage of the inspection area that is delaminated.

In some embodiments, the data processing unit may overlay the 2-D delamination contour map of the entire inspection area on a stitched image of the concrete structure. Additionally, in some embodiments, the data processing unit may overlay the 2-D delamination contour map of the entire inspection area on other geotag services provided by third-party providers (e.g., Google Maps™, Apple Maps™, etc.) for visualization purposes. In some embodiments, the data processing unit may overlay the 2-D delamination contour map of the entire inspection area on other contour maps produced using other NDE sensors. As a non-limiting example, the data processing unit may overlay the 2-D delamination contour map of the entire inspection area on a map of infrared (IR), ground penetrating radar (GPR), electrical resistivity (ER), impact echo (IE), ultrasonic surface waves (USW), etc.

In some embodiments, at faster testing speeds, shallow delamination flexural resonance mode may be excited to a greater extent and therefore produces more energy, increasing the energy difference between sound/intact areas and shallow delaminations. Furthermore, the energy difference between noise and shallow delaminations may be magnified at faster testing speeds.

In some embodiments, the non-destructive evaluation system for detecting delamination in structures may use chains with different material, coating, amount, size, length, configuration, mounting mechanism, ground contact area size. In some embodiments, the non-destructive evaluation system for detecting delamination in bridge decks may use other parts as alternative of chains, such as ball, roller, and gear.

In some embodiments, the non-destructive evaluation system for detecting delamination in structures may have capability to adjust chain orientation manually or automatically in the sound collecting chamber.

In some embodiments, the non-destructive evaluation system for detecting delamination in structures may utilize different size, shape, material wall to minimize noise. In some embodiments, the sound collecting chamber walls may be configured to isolate each sound collecting chambers acoustics from neighboring sound collecting chambers to prevent leakage and spatial blurring transversally and therefore help in accurately localizing and measuring the size of delamination. Similarly, in some embodiments, one or more additional microphones may be mounted outside the sound collecting chamber to help remove sound produced outside the sound collecting chamber.

In some embodiments, the non-destructive evaluation system for detecting delamination in concrete structures may improve sound collecting chamber design to minimize noise by using different material, shape, connection method, sealing material.

In some embodiments, the non-destructive evaluation system for detecting delamination in concrete structures may utilize different material such as foam to absorb noise to the microphone.

In some embodiments, the non-destructive evaluation system for detecting delamination in concrete structures may include other type of microphone, other brand of microphone. In some embodiments, the non-destructive evaluation system for detecting delamination in concrete structures may include another design of the microphone board to improve an output from the microphone, with different filter, signal-to-noise ratio, wider range of acceptable frequency and amplitude.

In some embodiments, the non-destructive evaluation system for detecting delamination in concrete structures may include different microphone mounting location, orientation, and number of microphones. In some embodiments, non-destructive evaluation system for detecting delamination in concrete structures may include different number of microphones on each microphone board, different total number of microphone board, and different mounting location of microphone board.

In some embodiments, the non-destructive evaluation system for detecting delamination in concrete structures may include fireproof chain. In some embodiments, the non-destructive evaluation system for detecting delamination in concrete structures may include a fireproof sound collecting chamber.

In some embodiments, the non-destructive evaluation system for detecting delamination in concrete structures may include lighter and more compact components to become more adaptable to other application.

In some embodiments, the non-destructive evaluation system for detecting delamination in concrete structures may include improved chain drag data spatial resolution and cover width. In some embodiments, the non-destructive evaluation system for detecting delamination in concrete structures may include improved data collection speed.

In some embodiments, the non-destructive evaluation system for detecting delamination in concrete structures may validate its capability to detect other defects of concrete structures such as debonding of overlay, spalling, and delaminated patches.

In some embodiments, the non-destructive evaluation system for detecting delamination in concrete structures may be utilized in other application where sounding technology is used, such as other bridge element inspection, tunnel inspection, pipe inspection, parking garage building inspection, airport runway inspection, dam inspection, chimney inspection or any other concrete structure inspection.

In some embodiments, the non-destructive evaluation system for detecting delamination in concrete structures may include an automated mechanism to deploy and home the chain (e.g., by using motor or actuator).

In some embodiments, the non-destructive evaluation system for detecting delamination in concrete structures may utilize machine learning (ML) and artificial intelligence (AI) for processing and analysis. The machine learning algorithm may be trained using signals collected from known delaminations to identify signal features related to amplitude, frequency content and relative energy distribution that can effectively be used to discern delamination signatures in the signal. Furthermore, the machine learning algorithm may be trained using signals collected from sound concrete to identify signal features related to amplitude, frequency content and relative energy distribution that pertain to sound concrete, to decrease the number of delamination false positives. Furthermore, the machine learning algorithm may be trained using signals and final contour maps to help discern and determine the optimal processing and normalization parameters by considering the inspection area characteristics and other available information. Furthermore, the machine learning algorithm may be trained to identify joint-chain interaction signature in the signal to help automatically isolate the inspection area (bridge deck) in the scan. Furthermore, the machine learning algorithm may be trained to discern between signatures in the signal produced by delaminations, debonding, and patching (sound and unsound).

Embodiments of the present disclosure may be implemented in various ways, including as computer program products that comprise articles of manufacture and may include one or more software components including, but not limited to, software objects, methods, and data structures. A software component may be coded in any of a variety of programming languages, e.g., an assembly language associated with a particular hardware architecture and/or operating system platform, which may require conversion into executable machine code by an assembler prior to execution by the hardware architecture and/or platform, a macro language, a shell or command language, etc. In one or more example embodiments, a software component including instructions in any suitable programming language may be executed directly by an operating system or other software component without having to be first transformed into another form. A software component may be stored as a file or other data storage construct. Software components of a similar type or functionally related may be stored together such as, for example, in a particular directory, folder, or library, and may be static (e.g., pre-established or fixed) or dynamic (e.g., created or modified at the time of execution).

A computer program product may include a non-transitory computer-readable storage medium storing application, programs, program modules, scripts, source code, program code, object code, byte code, compiled code, interpreted code, machine code, executable instructions, and/or the like. In some embodiments, the computer-readable storage medium may include a floppy disk, flexible disk, hard disk, solid-state storage, or any other non-transitory magnetic medium. In some embodiments, the computer-readable storage medium may include a non-volatile computer-readable storage medium such as a punch card, paper tape, optical mark sheet, compact disc read only memory (CD-ROM), CD-rewritable (CD-RW), digital versatile disc (DVD), Blu-ray disc (BD), read-only memory (ROM), programmable read-only memory (PROM), erasable programmable read-only memory (EPROM), electrically erasable programmable read-only memory (EEPROM), any type of flash memory, multimedia memory cards (MMC), secure digital (SD) memory cards, SmartMedia cards, CompactFlash (CF) cards, memory sticks, conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), silicon-oxide-nitride-oxide-silicon memory (SONOS), floating junction gate random access memory (FJG RAM), millipede memory, racetrack memory, random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), twin transistor RAM (TTRAM), Thyristor RAM (TRAM), Zero-capacitor (Z-RAM), Rambus in-line memory module (RIMM), dual in-line memory module (DIMM), single in-line memory module (SIMM), video random access memory (VRAM), cache memory, flash memory, register memory, and/or the like. It should be noted that where embodiments are described to use a computer-readable storage medium, other types of computer-readable storage media may be substituted for or used in addition to the computer-readable storage media described above.

Various embodiments of the present disclosure may be implemented as methods, apparatus, systems, computing devices, computing entities, and/or the like. As such, embodiments of the present disclosure may take the form of an apparatus, system, computing device, or computing entity executing instructions stored on a computer-readable storage medium to perform certain steps or operations. Thus, embodiments of the present disclosure may also take the form of an entirely hardware embodiment, an entirely computer program product embodiment, and/or an embodiment that includes combination of computer program products and hardware performing certain steps or operations. Each step or operation described herein may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing some of the embodiments.

Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

It will be appreciated that layers, features, elements, etc. depicted herein are illustrated with particular dimensions relative to one another, such as structural dimensions or orientations, for example, for purposes of simplicity and ease of understanding and that actual dimensions of the same differ substantially from that illustrated herein, in some embodiments.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for detecting delamination in structures, comprising:
obtaining a plurality of acoustic waves;
storing the plurality of acoustic waves;
calculating a short-term Fourier transform (STFT) spectrum for each of the plurality of acoustic waves, wherein each STFT spectrum comprises a plurality of window discrete Fourier transforms, and
detecting the delamination based on the STFT spectrum.

2. The method of claim 1, further comprising:
storing synchronous geotag data associated with each of plurality of acoustic waves, wherein the synchronous geotag data is determined by utilizing at least one of: an encoder, a Global Positioning System (GPS) data, an Inertial Measurement Unit (IMU) data, and a Light Detection and Raging (LiDAR) data.

3. The method of claim 2, further comprising:
prior to the detecting the delamination:
isolating an inspection area for detecting the delamination, and band passing-filter the plurality of acoustic waves.

4. The method of claim 3, wherein the isolating an inspection area is performed by using at least one of: a 360° video of the inspection area, a profiler position, the GPS data, the IMU data, the LiDAR data, and a Line Scan Camera (LSC) data.

5. The method of claim 1, further comprising:
calculating an average absolute amplitude for each acoustic wave of the plurality of acoustic waves, and
normalizing each average absolute amplitude.

6. The method of claim 1, wherein the detecting the delamination based on the STFT spectrum comprises:
identifying each acoustic wave of the plurality of acoustic waves having a resonance frequency between 0.5 kHz to 5 kHz;
calculating a total number of points based on a sampling rate for each STFT;
calculating a number of overlap points for each STFT;
calculating a signal energy curve over a first frequency range for each STFT, and
normalizing the signal energy curve for each STFT.

7. The method of claim 6, wherein the normalizing the signal energy curve is performed based at least in part on utilizing an asphalt energy.

8. The method of claim 6, wherein the first frequency range is between 1 kHz and 4 kHz.

9. The method of claim 1, further comprising:
cross-checking the plurality of acoustic waves to identify outlier acoustic waves, and
removing the outlier acoustic waves.

10. The method of claim 1, wherein the obtaining the plurality of acoustic waves comprises:
dragging a set of chains along a surface of the structure;
removing a first set of sounds created by the set of chains contacting the surface, and
removing a second set of sounds created by the set of chains contacting each other.

11. The method of claim 1, wherein the obtaining the plurality of acoustic waves comprises:
transmitting one or more acoustic waves towards the surface;
collecting reflected acoustic waves from the surface in response to transmitting the one or more acoustic waves, and
storing the collected acoustic waves.

12. The method of claim 1, wherein the detecting the delamination based on the STFT spectrum comprises:
calculating a signal energy for each STFT window by integrating the STFT spectrum over a second frequency range.

13. The method of claim 12, wherein an upper bound and a lower bound of the second frequency range are adjustable.

14. A system for detecting delamination in a structure, comprising:
a data acquisition unit, wherein the data acquisition unit is configured to:
obtain a plurality of acoustic waves, and
store the plurality of acoustic waves, and
a data processing unit, wherein the data processing unit is configured to:
calculate a short-term Fourier transform (STFT) spectrum for each of the plurality of acoustic waves, wherein each STFT spectrum comprises a plurality of window discrete Furrier transforms, and
detect the delamination based on the STFT spectrum.

15. The system of claim 14, wherein the data acquisition unit comprises:
one or more chambers;
one or more microphones configured to collect the acoustic waves, and
an apparatus coupled to the one or more microphones, the apparatus being configured to receive and store voltage signals, corresponding to the acoustic waves, from the one or more microphones.

16. The system of claim 15, wherein the data processing unit is further configured to calculate a mean energy of each of the one or more microphones for an entire scan to normalize an individual microphone’s STFT spectrum.

17. The system of claim 16, further comprising:
one or more chains, each chain being mounted inside each of the one or more chambers, wherein the one or more chains are configured to drag along a surface of the structure, and
a chain positioning unit configured to control movement of each chain,
wherein the acoustic waves are created by each chains dragging along a surface of the structure.

18. The system of claim 15, wherein at least one of the one or more chains is in contact with the surface at each time to ensure inspecting an entire surface of the structure, and wherein the chain positioning unit comprises a set of inverse T-shaped bars.

19. The system of claim 15, wherein the data acquisition unit further comprises a reconfigurable I/O module, and wherein at least one of the one or more microphones is a Micro-Electro-Mechanical-System (MEMS) microphone.

20. The system of claim 19, wherein a linear response of the MEMS microphone is about 124 dB sound pressure level, with a sensitivity tolerance of about 1 dB and an enhanced immunity to at least one of: a radiated Radio Frequency (RF) interference, and a conducted RF interference.
